(19) United States
(12) Patent Application Publication
(10) Pub. No.: US 2009/0118854 A1
(43) Pub. Date: May 7, 2009

(54) PRODUCTION PLANNING SUPPORT METHOD AND ITS SYSTEM

(76) Inventors: Maho URANO, Hadano (JP); Hidenori Ueno, Yokohama (JP); Akiko Takasuna, Ninomiya (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/258,692

(22) Filed: Oct. 27, 2008

(30) Foreign Application Priority Data
Nov. 6, 2007 (JP) 2007-288005

(51) Int. Cl. G06F 19/00

(52) U.S. Cl. 700/102; 700/107

(57) ABSTRACT

A production planning support method and a system thereof are disclosed, wherein in order to facilitate the change in the production plan to suppress the inventory increase, the future timing to order the parts with an increased order amount and the quantity of the parts already ordered for the production planning amount at a given timing are grasped in advance. The feature of the invention lies in that the part order timing information is collected for each order timing and converted into the amount of money thereby to calculate the order amount for each order timing. The result is formed into graphs, so that the production planning amount at a given timing and the order amount required for the parts to meet the production plan collectively shown for each period are presented as juxtaposed graphs to the user.

### INCORPORATION BY REFERENCE

The present application claims priority from Japanese application JP2007-288005 filed on Nov. 6, 2007, the content of which is hereby incorporated by reference into this application.

### BACKGROUND OF THE INVENTION

This invention relates to a technique for supporting a person in charge of the production planning to form/correct the production plan, or in particular to a system for supporting the change in the production plan to suppress the increase in the amount of the inventory assets by indicating what is a changeable production plan or an increased amount of the inventory assets in the case where the production plan for which the order has already been received is changed downward.

What is called a MRP (Material Requirements Planning) exists as a means of the material procurement planning which was proposed in the 1970 in US and which has recently come to find wide application. According to this method, a plan is formed to purchase or produce the required auxiliary items such as assemblies, parts and raw materials in the required quantity to meet the delivery time as required, based on the information including the production plan or the merchandising plan formed in terms of the product, the parts list, the stock/ordered amount (backlog). In the MRP calculation, an arrangement plan is formed by calculations to purchase and produce the required objects (items) to the required degree (in the required quantity) at the required time point (required to meet the delivery time) based on the production plan formed in terms of product (master production schedule, hereinafter referred to as MPS). Specifically, the lead time of each process is subtracted from the product delivery time (production plan in terms of the product) thereby to calculate the required time and the required quantity for each item of parts and raw materials (production plan in terms of the process). The MRP calculation normally requires three types of information including the MPS data, the part list and the stock/backlog data.

The MPS data is generally defined as a data indicating the production plan (how many products are required by when) of the item at the top level (i.e. the end product) in the part development diagram indicating the relation between the various parts of the product along the basic production procedure. The MPS is also called the standard production schedule.

The part list normally includes two master data of “item data” and “product configuration data”. The item data is a table containing the information unique to each item such as the time required to produce or purchase a particular part (hereinafter referred to as “the lead time”). The product configuration data, on the other hand, is the information indicating the relation between items, i.e. the product-to-part relation, the part-to-part relation and the part-to-material relation, or specifically, the information including a given item (called a parent item), a part required for producing the particular parent item (called a child item as an item underlying the parent item), and the quantity of each child item (called the constituent number of child item) required for producing a single particular parent item.

The stock/backlog data indicates the present quantity of the stock and the stock in process of each item, and the expected delivery time and the expected quantity (backlog information) of each item already ordered for future delivery.

The MRP calculation includes the following five types of calculations on each item based on the information described above.

### (1) Calculation of Total Required Quantity

The data on the required quantity of each item to be processed is read and the required quantity is determined for each period thereby to calculate the total required quantity for each period. To facilitate the understanding in the description that follows, assume that the period is one day and the plan is formed daily.

### (2) Calculation of Net Required Quantity

Based on the total required quantity calculated, the stock and the order backlog are reserved, and by subtracting the stock and the order backlog, the actually required quantity, i.e. the net required quantity is calculated on daily basis.

### (3) Quantity Determination by Lot

Based on the daily net required quantity thus calculated, the quantity is determined in lot size as set for each item.

### (4) Calculation of Starting Date

From the delivery time for the quantity determined by lot, the lead time is subtracted, and the order date or the starting date for the order is calculated thereby to prepare an order.

### (5) Development of Required Quantity

The prepared order is developed to low-level items using the part list. Specifically, assuming that the day immediately preceding to the starting date for the order is the requirement date, the required quantity of each child item is calculated based on each child item and the number thereof required for each parent item in the product configuration data.

By executing the steps (1) to (5) described above, a plan is formed for one item. These steps are collectively called the part development calculation. The MRP calculation is the part development calculation process (MRP development) executed for all the items, sequentially from highest to lowest level, registered in the part list and required for production of all the products set in MPS. In the case where the merchandising plan and the estimated actual sales quantity are different from each other, an inventory calculation simulation method for accurately predicting the future inventory is available, in which the time point constituting the basis of the MRP calculation is advanced into the future and the MRP calculation is made for each time point so that the stock is calculated from the warehousing/shipment quantity thereby to determine the stock change for each time point. (see JP-A-2004-161437).

In the prior art, the future change in the inventory can be calculated using the production plan formed at the present time. It is difficult, however, to know the detailed information on each production plan such as what is a changeable production plan or what is a production plan for which many parts are already ordered. Conventionally, therefore, the person in charge of production planning is unable to change the production plan instantaneously to suppress the inventory increase.

Also, the sales department cannot be easily requested to promote the sale of a given product nor the material purchase department can be easily requested to shorten the procurement lead time. Thus, neither the measure nor the proposition to reduce the inventory can be carried out instantaneously.

In order to facilitate the preparation of a proposition to change the production plan for suppressing the inventory increase, a support system is required to easily grasp, in advance, how many parts are already ordered and at what future timing the parts are to be ordered with an increased order amount with respect to the production planning amount at a given timing.

### SUMMARY OF THE INVENTION

In order to solve the problem described above, the object of this invention is to provide a production planning support method and a system thereof: wherein the part order timing information including when the parts required for production at a given timing are ordered or required to be ordered in the future is determined for each order timing and converted into an amount of money thereby to calculate the order amount for each order timing, the result of this calculation is formed into a graph, and the production planning amount at a given timing and the order amount of the parts required for the particular production are displayed in juxtaposition with each other for each period, so that the person in charge of the production planning can grasp, in advance, how many parts have already been ordered or to be ordered at what future timing with an increased order amount, thereby making it possible to change the production plan without increasing the inventory; and wherein the proposition of the extraneous stock ordered can determine the parts of which the material purchase department is requested to shorten the procurement lead time on the one hand and the products of which the sales department is requested to promote the sale on the other hand.

According to the present invention, there is provided a production planning support method and a system thereof to support the production planning of products having the parts different in procurement lead time, comprising:

a storage unit for recording the production information including the production achievement information and the production planning information, the MRP information including the initial stock information, the ordered amount information, the part list information and the various lead time information, the amount information including the product and part cost information, the expected order information, the order amount information, and the calculation result information including the production schedule and achievement amount information;

an expected order amount calculation unit supplied with the part list information, the lead time information, the initial stock information, the production planning information and the ordered amount information to calculate the expected order information;

a production planning and achievement amount/order amount calculation unit supplied with the expected order information, the initial stock information, the ordered amount information and the cost information to calculate the order amount information on the one hand and supplied with the production planning information, the production achievement information and the cost information to calculate the production planning and achievement amount information on the other hand;

a production planning and achievement amount/order timing display information calculation unit for preparing a collective order amount table collectively showing the order amount of the order amount information for the same completion date and the same order date and a collective production planning and achievement amount table collectively showing the production amount of the production planning and achievement amount information for the same completion date, and based on these information, preparing a production planning and achievement amount/order timing confirmation graph including a first bar graph with the abscissa representing the period and the ordinate the amount for showing the production amount at the position corresponding to each period and a second bar graph, displayed in juxtaposition with the first bar graph, for identifying and adding, in chronological order of the order time point, the order amounts in the collective order amount table with the particular period in a data record: and

a unit for displaying the graph.

The person in charge of the production planning can be informed of what is a changeable production plan and grasp the stock amount with the production plan changed downward with many ordered parts. In this way, the inventory increase is suppressed, and an early proposition and execution of an action is made possible thereby to reduce the risk of an increased inventory. Also, the parts of which the material purchase department is requested to shorten the procurement lead time can be determined and so can the parts of which the sales department is requested to promote the sale.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the configuration of a production planning support system.

FIG. 2 is a traced drawing showing a production planning support system.

FIG. 3 shows the processing steps for the order timing calculation unit.

FIG. 4 shows an example of the part list.

FIG. 5 shows an example of the procurement information.

FIG. 6 shows an example of the initial stock information.

FIG. 7 shows an example of the order backlog information.

FIG. 8 shows an example of the production planning information.

FIG. 9 shows an example of the expected order information.

FIG. 10 shows an example of the cost information.

FIG. 11 shows an example of the order amount information.

FIG. 12 shows an example of the production achievement information.

FIG. 13 shows an example of the production planning and achievement amount information.

FIG. 14 shows an example of the collective order amount information.

FIG. 15 shows an example of the collective production planning and achievement amount information.

FIG. 16 shows a display example of the production planning and achievement amount/order timing confirmation graph.

### DESCRIPTION OF THE INVENTION

A production planning support system according to an embodiment of the invention is explained below.

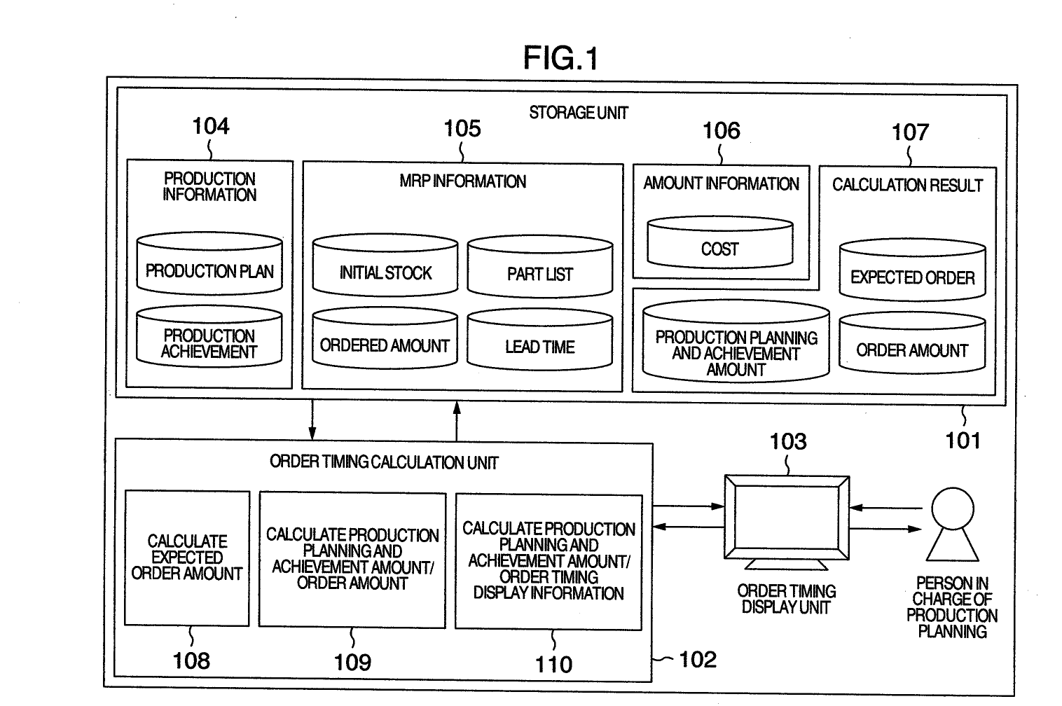

FIG. 1 is a diagram showing a general configuration of the system according to the invention. This system is roughly divided into three units including a storage unit (101), an order timing calculation unit (102) and an order timing display unit (103).

The storage unit (101) stores the production information (104) including the production planning information and the production achievement information, the MRP information (105) including the initial stock quantity, the ordered amount, the part list and the various lead time information required for production and part procurement which are necessary for calculation of the required quantity of the parts and the new order amount and date from the production plan, the amount information (106) containing the cost information for all the items, and the various calculation result information (107) including the expected order information containing the expected order amount and date determined by the order timing calculation unit, the order amount information, the production planning amount information and the production achievement amount information.

Also, the order timing calculation unit (102) is configured of three calculation engines including an expected order amount calculation engine (108), a production planning and achievement amount/order amount calculation engine (109), and a production planning and achievement amount/order timing display information calculation engine (110).

In the order timing display unit (103), the person in charge of the production planning reads the required data from the storage unit based on the input command for starting the system operation and calculation, conducts the three calculations of the order timing calculation unit sequentially, and holds the result of the calculations in the storage unit while at the same time outputting the result to the order timing display unit (103). The person in charge of the production planning proposes/corrects the production plan based on the result output to the order timing display unit. The invention has this system configuration.

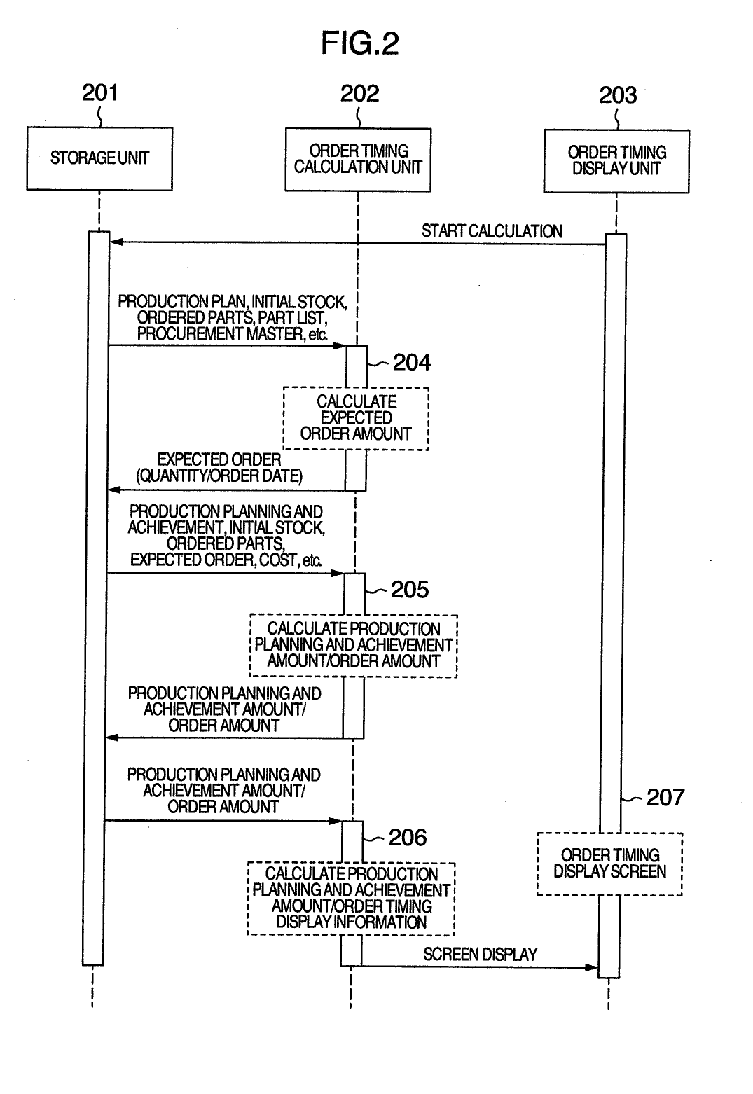

FIG. 2 shows the processing flow indicated in a traced drawing according to the invention. This system is configured of three units as component elements including the storage unit (201), the order timing calculation unit (202) and the order timing display unit (203). First, in response to a calculation start command from the person in charge of the production planning, the production plan, the initial stock quantity, the ordered amount, the part list and the procurement information are read from the storage unit (201), and the expected order amount is calculated (204) by the order timing calculation unit (202). As a result, the expected order information (quantity/order date) is output. Next, the production plan, the initial stock quantity, the ordered amount, the expected order amount and the cost information on all the items are read, and the production planning and achievement amount/order amount is calculated (205) by the order timing calculation unit (202). As a result, the production planning amount, the production achievement amount and the order amount information are acquired.

Finally, based on the production planning amount, the production achievement amount and the order amount, the order timing calculation unit (202) calculates the production planning and achievement amount/order timing display information (206). As a result, a collective order amount table, a collective production planning and achievement amount table, and a production planning and achievement amount/order timing confirmation graph are acquired and displayed on the order timing display screen (207) of the order timing display unit (203). A series of processes are traced above according to the invention.

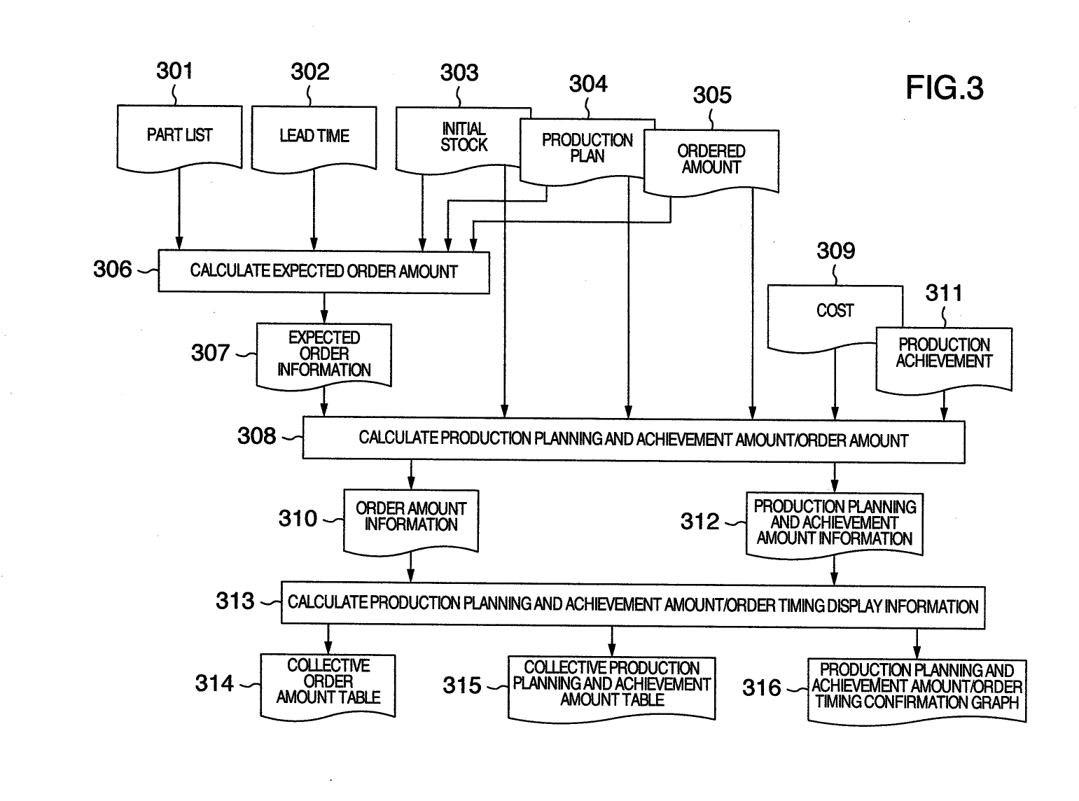

Next, FIG. 3 is explained. FIG. 3 is a flowchart showing the steps of the process executed in the order timing calculation unit.

First, the part list (301), the lead time (302), the initial stock quantity (303), the production plan (304) and the ordered amount (305) are input to calculate the expected order amount (306).

First, the various input files are explained.

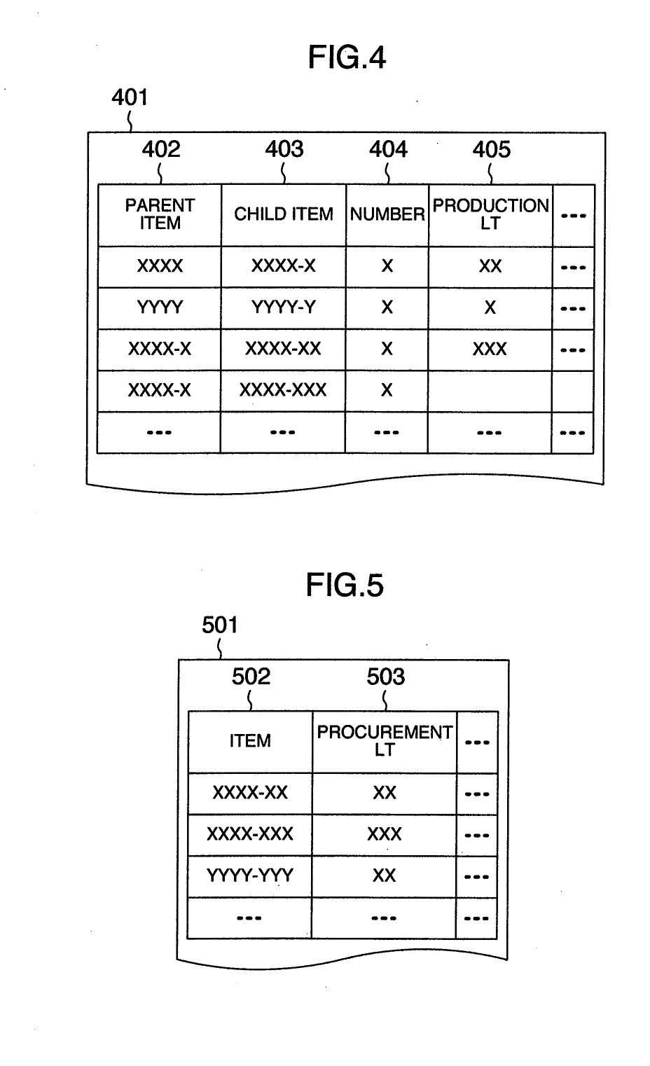

FIG. 4 shows an example of a part list file (401). The part list (401) defines a product, how many of what parts and what products in process and the time required for fabricate them to produce the particular product, and has registered therein the data record configured of the data items including at least parent items (402), child items (403), the number of the child items required to make up each parent item (404) and the production lead time (405).

FIG. 5 shows an example of the procurement information file (501). This file defines the procurement lead time required for procuring each part, and has registered therein the data record configured of the data items including at least the items (502) and the procurement lead time (503).

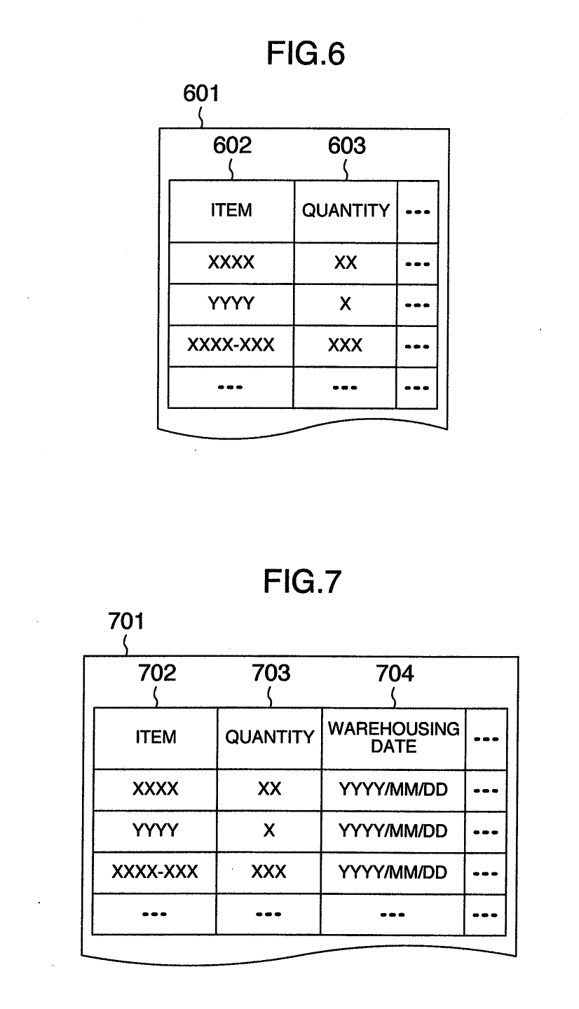

FIG. 6 shows an example of the initial stock information file (601). This file has registered therein the data record configured of the date items including at least the items (602) and the quantity (603). The items (602) can include all items in stock such as the parts, the products in process and the products.

FIG. 7 shows an example of the order backlog information file (701). This file has described therein the items already ordered and the quantity information thereof, and has registered therein the data record configured of the data items including at least the items (702), the quantity (703) and the warehousing date (704).

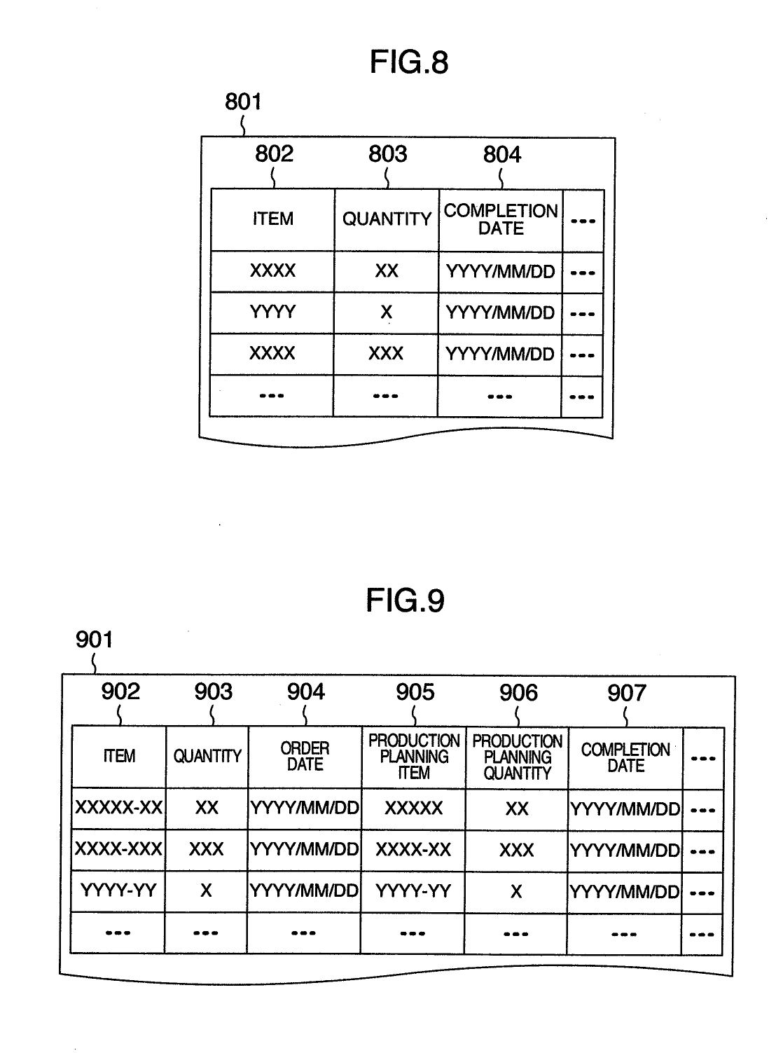

FIG. 8 shows an example of the production planning information file (801). This file has described therein the desired quantity of the products to be produced and the date on which the products are completed (hereinafter referred to as the product completion date or the completion date), and has registered therein the data record configured of the data items including at least the items (802), the quantity (803) and the product completion date (804).

Using the file information shown in FIGS. 4 to 8, the MRP calculation is made as the process of the expected order amount calculation (306) shown in FIG. 3 thereby to calculate the required quantity of the parts, i.e. how many of a particular part are required when, to fulfill the production planning information (801) shown in FIG. 8. In the process, the expected order information (307) is prepared by calculations and stored in the calculation result data base of the storage unit (201) shown in FIG. 2.

FIG. 9 shows an example of the expected order information file (901). This file describes the calculation result, i.e. “which item (part)” is required to be ordered “when” and “how many” to fulfill the production plan (“what product” is produced “when” and “how many”), and has registered therein the data record configured of the data items including at least the part item (902), the quantity (903), the order date (904), the production planning item (905), the production planning quantity (906) and the completion date (907). Normally, the expected order information (901) has no description of the production planning item (905), the production planning quantity (906) and the product completion date (907) for each item. According to this invention, however, the three information are added to clearly define which production plan is to be met by the ordered parts. As described in detail later, it is possible to clearly grasp until which period how many parts are scheduled to be ordered or how many parts have already been ordered for the production plan of each period.

Next, an explanation is given about the production planning and achievement amount/order amount calculation (308) corresponding to the process of the second step in the order timing calculation unit shown in FIG. 3. This step is roughly divided into two parts.

In the first part of the step, the quantity data including the expected order information (307), the initial stock (303) and the ordered amount (305) determined by the expected order amount calculation (306) is multiplied by the cost information (309) providing the amount data per item to prepare the order amount information (310).

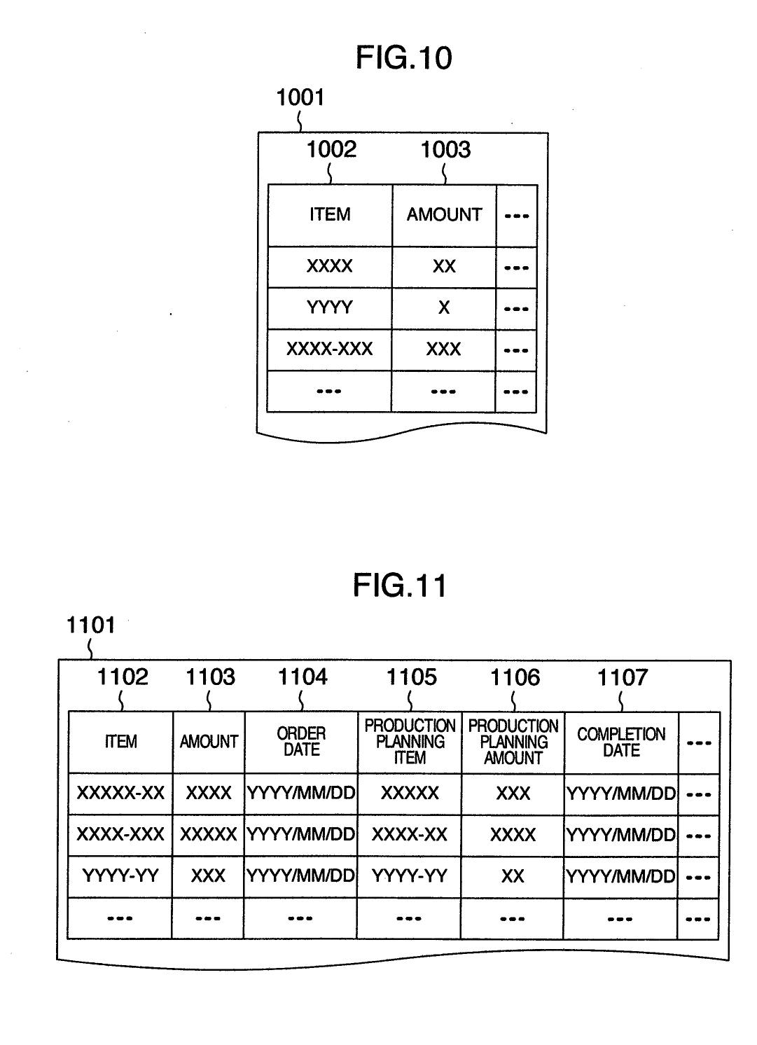

FIG. 10 shows an example of the cost information file (1001). This file has registered therein the data record configured of the data items including at least the item (1002) and the amount (1003). This file has registered therein all other items (1002) such as the parts, the products in process and the products and the amount (1003).

FIG. 11 shows an example of the order amount information file (1101). This file is output as the result of the production planning and achievement amount/order amount information calculation (308) constituting the second step of the process executed by the order timing calculation unit shown in FIG. 3. In each of the item (1102) and the production planning item (1105), the amount information (1003) of the item coinciding with any one in the item (1002) column shown in FIG. 10 is extracted, and multiplied by the quantity (903) and the production planning quantity (906), respectively, thereby to calculate the amount (1103) and the production planning amount (1106) shown in FIG. 11. This file has registered therein the data record configured of the data items including at least the item (1102), the amount (1103), the order date (1104), the production planning item (1105), the production planning amount (1106) and the product completion date (1107).

The second part of the step executed for the production planning and achievement amount/order amount calculation (308) is to prepare the production planning and achievement amount information (312) by multiplying the quantity data including the production plan (304) and the production achievement information (311) by the cost information (309) providing the amount data per item.

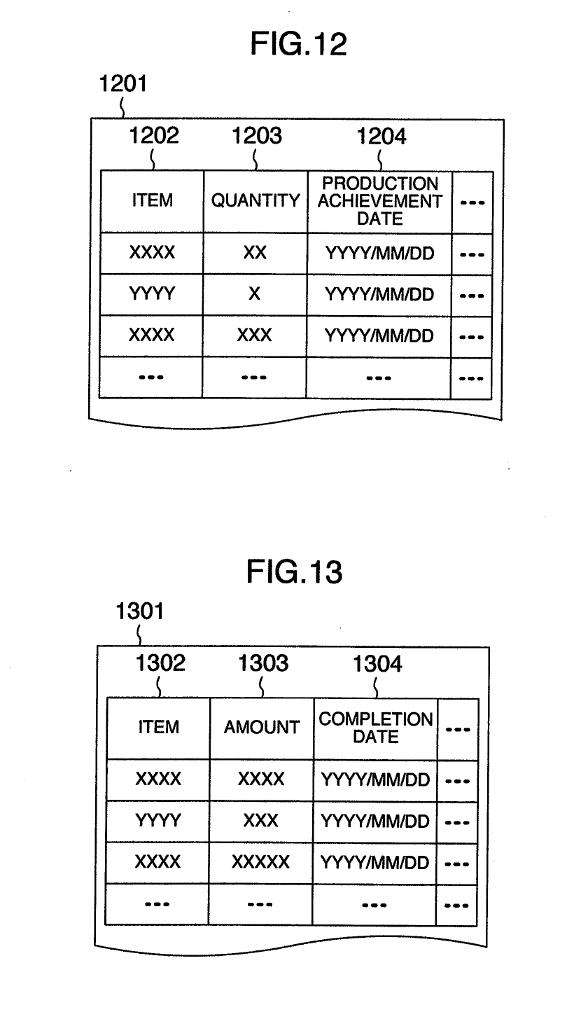

FIG. 12 shows an example of the production achievement information file (1201). This file indicates the production achievement up to the present time, and has registered therein the data record configured of the data items including at least the item (1202), the quantity (1203) and the production achievement date (1204). The user can arbitrarily set the range of the time during which the data of the production achievement information is acquired.

FIG. 13 shows an example of the production planning and achievement amount information (312). In preparing this file, the quantity data including the production planning information (801) shown in FIG. 8 or the production achievement information (1201) shown in FIG. 12 is multiplied by the cost information (1001) shown in FIG. 10 providing the amount data per item. The production planning and achievement amount information is the data record configured of the data items including at least the item (1302), the amount (1303) and the product completion date (1304), and the calculation result is stored in the storage unit (101).

Finally, the production planning and achievement amount/order timing display information calculation (313) which is the third step of the process executed by the order timing calculation unit shown in FIG. 3 is explained. In the third step, a collective table and a graph are prepared to permit the user to instantaneously confirm the result of the previous calculation. In preparing the collective table and the graph, two files including the collective order amount table (314) and the collective production planning and achievement amount table (315) are created.

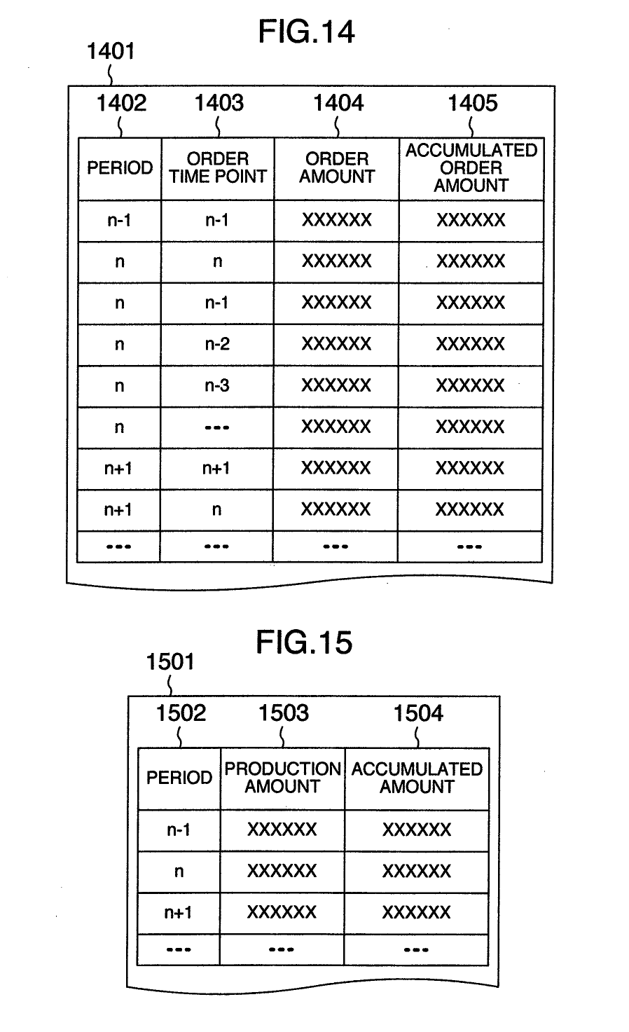

FIG. 14 shows an example of the collective order amount table (1401). This file is created on the basis of the order amount information (1101) shown in FIG. 11. Prior to the creation, the user arbitrarily sets and inputs the unit such as “daily”, “weekly” or “monthly” of the data items including the period (1402) and the order time point (1403) arbitrarily as the unit period for which the data are collected. The data record of the collective order amount table (1401) is prepared in the steps described below or equivalent steps. Specifically, in all the data records of the order amount information (1101) shown in FIG. 11, those having the same product completion date (1107) are collected and separated into groups each as a collection for the unit period set above. Further, in all the data records of the groups for the each period, those having the same order date (1104) are collected and separated into groups each as a collection for the unit of the order time point set in the same unit as the period set above. With regard to the data record of the order amount information (1101) collected into groups for each period or each order time point as described above, the amounts (1103) of all the data records are added and stored in the data item of the order amount (1404) of the data record in the collective order amount table (1401). In this case, the period (1402) and the order date (1104) of the data record in the collective order amount table (1401) each constitute a period containing the product completion date (1107) and the order date (1104), respectively, of the collective order amount information (1101) formed at the time of grouping. Incidentally, the order amount (1404) indicates the ordered amount (1404) in the case where the order time point (1403) is earlier than the present period (present date), and the expected order amount (1404) in the case where the order time point (1403) is advanced from the present period (present date). Further, the accumulated order amount (1405) is the accumulation of the order amount (1404) in the chronological order of the order time point (1403) for the same period, and the amount thus accumulated is substituted into the accumulated order amount (1405).

FIG. 15 shows an example of the collective production planning and achievement amount information (1501). This file is prepared based on the production planning and achievement amount information (1301) shown in FIG. 13. Prior to the preparation of this file, as in the case of the collective order amount table (1401) described above, the user arbitrarily sets and inputs the units of the data items of the period (1502) such as “daily”, “weekly” or “monthly” as a data collection unit period. The data record of the collective production planning and achievement amount information (1501) is prepared in the following steps or equivalent steps. Specifically, in all the data records in the production planning and achievement amount information (1301) shown in FIG. 13, those having the same product completion date (1304) are collected and further grouped into a collection for the set unit period. Then, the amounts (1303) of all the data records of the production planning and achievement amount information (1301) grouped for each period are added up and stored in the data item of the production amount (1503) of the data record in the collective production planning and achievement amount table (1501). In this case, the period (1502) of the data record in the collective production planning and achievement amount table (1501) contains the product completion date (1304) of the production planning and achievement amount information (1301). Incidentally, the production amount (1503) indicates the production achievement amount (1503) for the period (1502) earlier than the present period (present date), and the production planning amount (1503) for the period (1502) including and later than the present period (present date). Further, the accumulated value of the production amount (1503) is substituted into the accumulated production amount (1504) in the chronological order of the period (1502).

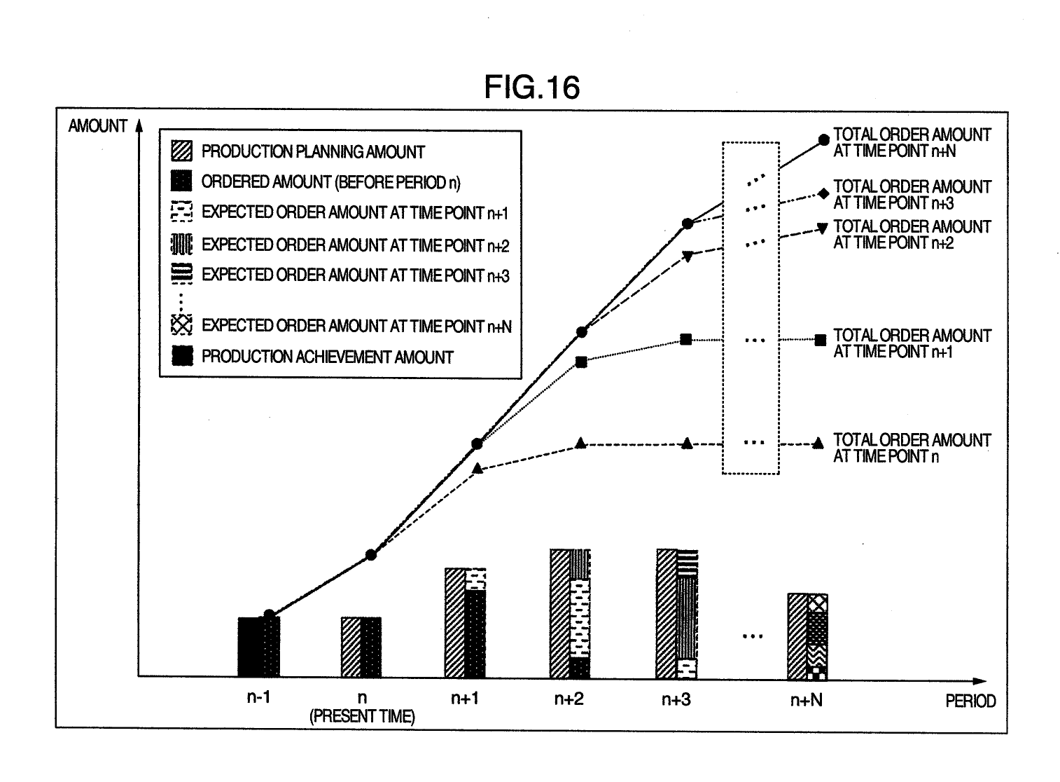

As described above, the production planning and achievement amount/order timing confirmation graph (316) shown in FIG. 16 is prepared from the collective order amount table (1401) shown in FIG. 14 and the collective production planning and achievement amount table (1501) shown in FIG. 15. In the production planning and achievement amount/order timing confirmation graph, the abscissa represents the period and the ordinate the amount of money. On the left side of each period, the production amount (1503) of the data record having the same period (1502) as the collective production planning and achievement amount table (1501) is added in the chronological order of the order time point (1403) and displayed in a bar graph. Similarly, on the right side of each period, the order amount (1404) of the data record having the same period (1402) as the collective order amount table (1401) shown in FIG. 14 is added in the chronological order of the order time point (1403) and displayed in a bar graph. In the process, the order amount is indicated by the right bar graph with a different color for a different order time point to make identifiable each order time point. The horizontal juxtaposition of the production amount and the order amount for each period in the form of bar graphs as described above makes it possible to easily determine a particular time point when the parts are required to be ordered to meet the production schedule of each period. Also, the production plan with many parts already ordered can be easily known, and therefore, in the case where the production plan is changed downward, the degree to which the stock amount increases can be grasped instantaneously from the bar graphs.

Also, the accumulation polygonal graphs of FIG. 16 each represent the accumulation of the order amount indicating the degree to which the parts required to fulfill the production schedule for each period are ordered at each time point. The polygonal graph of the total order amount at time point n, for example, indicates the order amount of the parts required to be ordered before time point n to fulfill the production schedule for each period. Specifically, with regard to all the data records in the collective order amount table (1401) of FIG. 14 with the order time point (1403) before n, the order amount (1404) of those data records in which the period (1402) is identical with the period of the accumulation polygonal graph are totalized and accumulated in chronological order of the period to form a graph.

The polygonal graph of the total order amount at time point n+1, on the other hand, indicates the order amount of the parts required to be ordered before time point n+1 to fulfill the production schedule for each period. This graph is prepared in the same manner as that for time point n.

Specifically, assuming that the time point n−1 is the beginning of the period and the time point n+N the end of the period, the total order amount at time point n+N corresponds to the total order amount for the current period. By comparing the total order amount at each time point with the total order amount at time point n+N, therefore, it is understood that about one half of the total order amount for the current period is ordered by time point n.

Also, observation of this graph indicates which production plan is difficult to change (a plan for which many parts required for production are already ordered), and therefore, the sales department can be requested to promote the sales. Further, the order amount at each time point can be grasped in detail, and therefore, it is understood that regardless of a future plan, a large amount of order is issued at an early time. With regard to such items, the material purchase department can be requested to shorten the procurement lead time, while at the same time making it possible to present the effect of reducing the inventory.

According to this invention, the person in charge of the production planning specifies a changeable production plan at the time of forming/correcting a production plan. Also, a support system is realized whereby the stock amount can be easily grasped in the case where the production plan with many parts already ordered is changed downward.

It should be further understood by those skilled in the art that although the foregoing description has been made on embodiments of the invention, the invention is not limited thereto and various changes and modifications may be made without departing from the spirit of the invention and the scope of the appended claims.

1. A production planning support method to support the production planning of products with the procurement lead time varied from one part to another;
wherein a storage unit has a data space configured in advance to record the production information including the production achievement information and the production planning information, the MRP (Material Requirements Planning) information including the initial stock information, the ordered amount information, the part list information and the various lead time information, the amount information having the cost information of the products and the parts, and the calculation result information including the expected order amount information, the order amount information and the production planning and achievement amount information;
the method comprising the steps of:
calculating the expected order amount information based on the input of the part list information, the lead time information, the initial stock information, the production planning information and the ordered amount information;
calculating the ordered amount information based on the input of the expected order information, the initial stock information, the ordered amount information and the cost information;
calculating the production planning and achievement amount information based on the input of the production planning information, the production achievement information and the cost information;
preparing a collective order amount table collectively showing the order amount for the same completion date and the same order date from the order amount information and a collective production planning and achievement amount table collectively showing the production amount for the same completion date from the production planning and achievement amount information, and based on these information, preparing a production planning and achievement amount/order timing confirmation graph including a first bar graph with the abscissa representing the period and the ordinate the amount to show the production amount at the position corresponding to each period and a second bar graph, displayed in juxtaposition with the first graph, in which the order amount in the collective order amount table having the particular period as a data record is identified and added in chronological order of the order time point: and
presenting the graphs to the user.

2. The production planning support method according to claim 1, further comprising the steps of:
preparing an accumulation polygonal graph of the total order amount at time point n in which the order amount of all the data records having the order time point before n and the same period as the accumulation polygonal graph are totalized and accumulated in chronological order of the period; and
presenting the accumulation polygonal graph to the user.

3. The production planning support method according to claim 1,
wherein the expected order information including the items and quantity required for the production planning is calculated as related to the product information for the order timing and the production planning.

4. The production planning support method according to claim 1,
wherein a production planning and achievement amount/order timing confirmation graph, including a first bar graph with the abscissa representing the period and the ordinate the amount to show the production amount at the position corresponding to each period and a second bar graph in which the order amount in the collective order amount table having the particular period as a data record is identified and added in chronological order of the order time point and which is displayed in juxtaposition with the first graph, is prepared in such a manner that each order time point is indicated by a different color.

5. A system for supporting the production plan for products formed of parts each having a different procurement lead time, comprising:
a storage unit for recording the production information including the production achievement information and the production planning information, the MRP information including the initial stock information, the ordered amount information, the part list information and the various lead time information, the amount information including the product and part cost information, and the calculation result information including the expected order information, the order amount information and the production planning and achievement amount information;
an expected order amount calculation unit for calculating the expected order information based on the input of the part list information, the lead time information, the initial stock information, the production planning information and the ordered amount information;
a production planning and achievement amount/order amount calculation unit for calculating the order amount information based on the input of the expected order information, the initial stock information, the ordered amount information and the cost information on the one hand and calculating the production planning and achievement amount information based on the input of the production planning information, the production achievement information and the cost information on the other hand;
a production planning and achievement amount/order timing display information calculation unit for preparing a collective order amount table collectively showing the order amount for the same completion date and the same order date from the order amount information and a collective production planning and achievement amount table collectively showing the production amount for the same completion date from the production planning and achievement amount information, and based on these information, preparing a production planning and achievement amount/order timing confirmation graph including a first bar graph with the abscissa representing the period and the ordinate the amount to show the production amount at the position corresponding to each period and a second bar graph, displayed in juxtaposition with the first graph, in which the order amount in the collective order amount table having the particular period as a data record is identified and added in chronological order of the order time point: and
a unit for displaying the graphs.

6. The production planning support system according to claim 5,
wherein the production planning and achievement amount/order timing display information calculation unit further prepares an accumulation polygonal graph of the total order amount at time point n in which the order amount of all the data records having the order time point before n and the same period as the accumulation polygonal graph are totalized and accumulated in chronological order of the period; and
wherein the graph display unit displays the accumulation polygonal graph.

7. The production planning support system according to claim 5,
wherein the expected order amount calculation unit calculates the expected order information including the items and the quantity required for the production plan as related to the product information for the order timing and the production plan.

8. The production planning support system according to claim 5,
wherein the production planning and achievement amount/order timing display information calculation unit prepares a production planning and achievement amount/order timing confirmation graph, including a first bar graph with the abscissa representing the period and the ordinate the amount to show the production amount at the position corresponding to each period and a second bar graph in which the order amount in the collective order amount table having the particular period as a data record is identified and added in chronological order of the order time point and which is displayed in juxtaposition with the first graph, in such a manner that each order time point is indicated by a different color.
